(19) United States
(12) Patent Application Publication
(10) Pub. No.: US 2015/0185704 A1
(43) Pub. Date: Jul. 2, 2015

(54) Electronic watch structure capable of selectively mounting a camera lens

(71) Applicant: Tau-Jeng Hsu, Shenzhen (CN)

(72) Inventor: Tau-Jeng Hsu, Shenzhen (CN)

(21) Appl. No.: 14/142,972

(22) Filed: Dec. 30, 2013

(51) Int. Cl. G04G 21/00; G04G 17/08

(52) U.S. Cl. CPC G04G 21/00; G04G 17/08

(57) ABSTRACT

An electronic watch structure includes a main housing and an optical assembly. The main housing defines a substantially inverted cone-shaped recess at a lateral side thereof that accommodates therein a CMOS image sensor being electrically connected to a control board within the main housing. The optical assembly can be constructed of a wide-angle lens module for providing a wider angle of view, a telephoto lens module for bringing distant objects closer, a close-up lens module for monitoring miniature objects, or a filtering module for reducing undesired light. The electronic watch structure allows a user to select a specific optical assembly and mount it into the recess of the main housing according to an application requirement. As such, the photographing or videoing function of the electronic watch can be significantly increased.

### BACKGROUND OF THE INVENTION

1. Field of the Invention

The invention relates to an electronic watch structure and, more particularly, to an electronic watch structure that can be selectively and releasably mounted with a specific optical assembly to meet a user's need.

2. Description of Related Art

Currently, the CMOS (complementary metal-oxide-semiconductor) image sensors of the built-in cameras of the existing electronic watches have the advantages of lower power consumption, small volume, and easy integration with the peripheral circuits thereof. However, the optical lenses of the built-in cameras, which have a fixed focal length, are permanently mounted to the electronic watches, namely that the existing electronic watches cannot change the focal length of the associated built-in cameras for enlarging or reducing the views. Therefore, when an application requires a wider angle of view, a telephoto view, a close-up view, or a filter for reducing ambient light, a user should carry a separate high-level professional camera, which is usually heavy and large, in addition to the electronic watches, which may cause inconvenience in taking photographs and carrying the devices.

In view of the foregoing, there is a need to provide an electronic watch structure that can be selectively mounted with an optical lens to facilitate the operation of taking photographs, and the optical lens will not protrude from the electronic watch structure after mounting the optical lens.

### SUMMARY OF THE INVENTION

The primary object of the invention is to provide an electronic watch structure that can be selectively and releasably mounted with a specific optical assembly to meet a user's need.

The secondary object of the invention is to provide an electronic watch structure that can be carried by the user more conveniently.

To achieve the above objects, the electronic watch structure may comprise a main housing and an optical assembly, wherein the main housing defines a substantially inverted cone-shaped recess at a lateral side thereof that accommodates therein a CMOS image sensor being electrically connected to a control board within the main housing. The optical assembly can be selectively and releasably mounted into the inverted cone-shaped recess corresponding to the CMOS image sensor. The optical assembly can be constructed of a wide-angle lens module for providing a wider angle of view, a telephoto lens module for bringing distant objects closer, a close-up lens module for monitoring miniature objects, or a filtering module for reducing undesired light.

Other objects, advantages, and novel features of the invention will become more apparent from the following detailed description when taken in conjunction with the accompanying drawings.

### BRIEF DESCRIPTION OF THE DRAWINGS

FIG. 1 shows an exploded view of a first embodiment of the invention.

FIG. 2 shows an assembled view of the first embodiment of the invention.

FIG. 3 shows a working view of the first embodiment of the invention, wherein the rotatable disk of the pivotal adjustment plate of the supportive frame is rotated by 90 degrees from the original orientation.

FIG. 4 shows another working view of the first embodiment of the invention, wherein the pivotal adjustment plate of the supportive frame is adjusted at a slope.

FIG. 5 shows an application view of the first embodiment of the invention, wherein a user can employ the electronic watch to take photographs while in joggling.

FIG. 6 shows another application view of the first embodiment of the invention, wherein a user can employ the electronic watch to take photographs while in cycling.

FIG. 7 shows an exploded view of a second embodiment of the invention.

FIG. 8 shows an assembled view of the second embodiment of the invention.

FIG. 9 shows a working view of the second embodiment of the invention, wherein the rotatable disk of the base frame is rotated by 90 degrees from the original orientation

FIG. 10 shows an application view of the second embodiment of the invention, wherein the electronic watch can be mounted on a front side of a vehicle for serving as a drive recorder.

FIG. 11 shows another application view of the second embodiment of the invention, wherein a user can wear the electronic watch on his head to take photographs while in joggling.

FIG. 12 shows another application view of the first embodiment of the invention, wherein a user can wear the electronic watch on his helmet to take photographs while in cycling.

FIG. 13 shows a sectional view of the first embodiment of the invention, wherein the optical assembly is taken from the main housing of the electronic watch structure.

FIG. 14 shows another sectional view of the first embodiment of the invention, wherein the optical assembly is mounted into the main housing of the electronic watch structure.

### DETAILED DESCRIPTION OF THE INVENTION

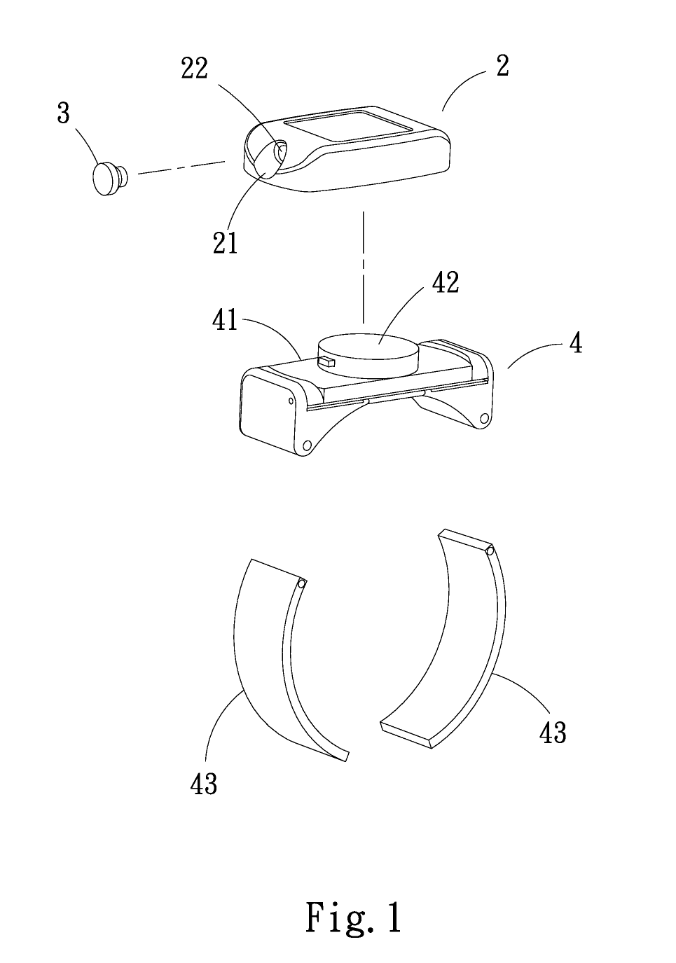

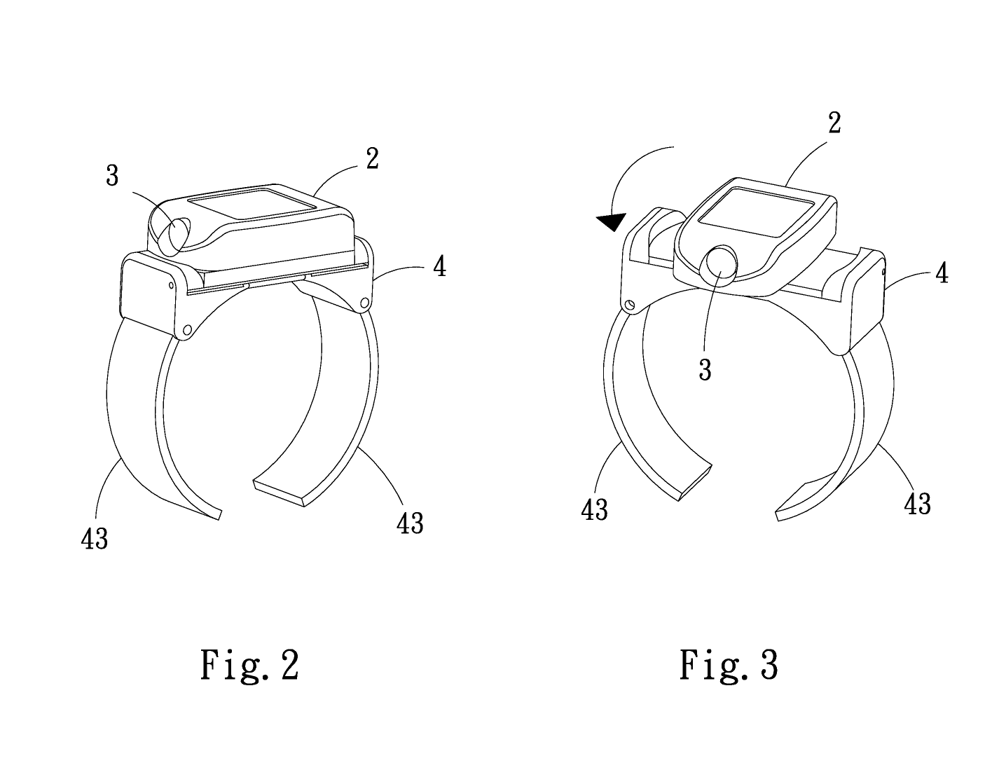

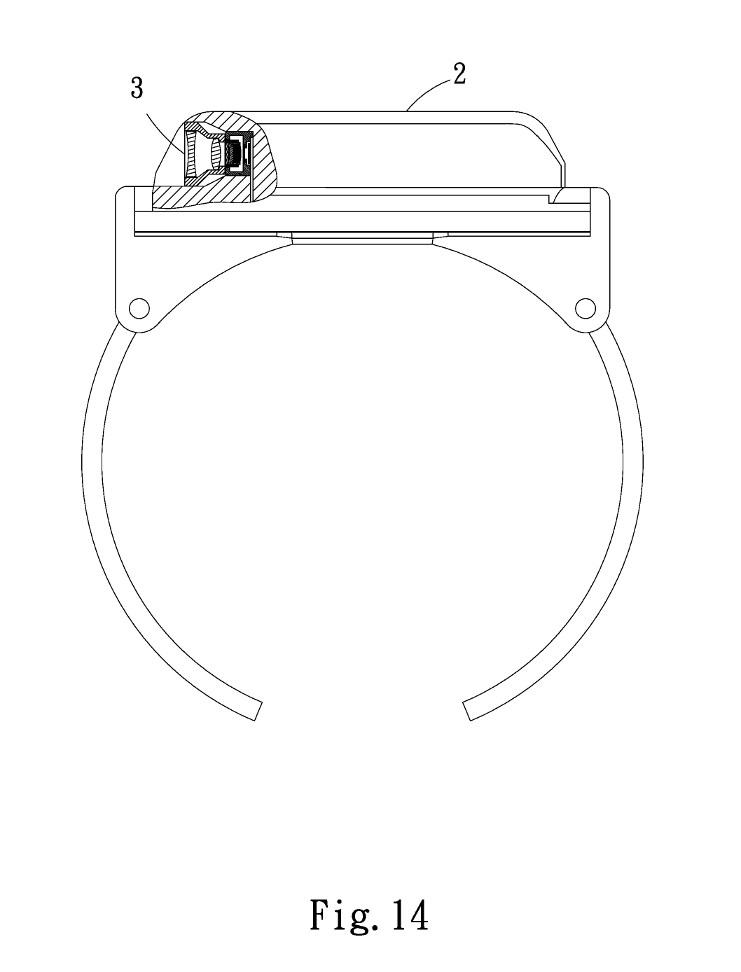

A first embodiment of the invention, concerning an electronic watch structure, is shown in FIGS. 1 through 6, 13 and 14, wherein the electronic watch structure 1 generally comprises a main housing 2, an optical assembly 3, and a supportive frame 4. The supportive frame 4 includes a pivotal adjustment plate 41 that is provided with a rotatable disk 42 on a top surface thereof. The main housing 2 can be mounted onto the rotatable disk 42 of the pivotal adjustment plate 41 of the supportive frame 4. The supportive frame 4 is provided with two arch-shaped members 43 at its bottom for clamping around a user's hand. Alternatively, other holding means, such as a wristband, a bracelet, a fastening strap and the like, can be employed as well.

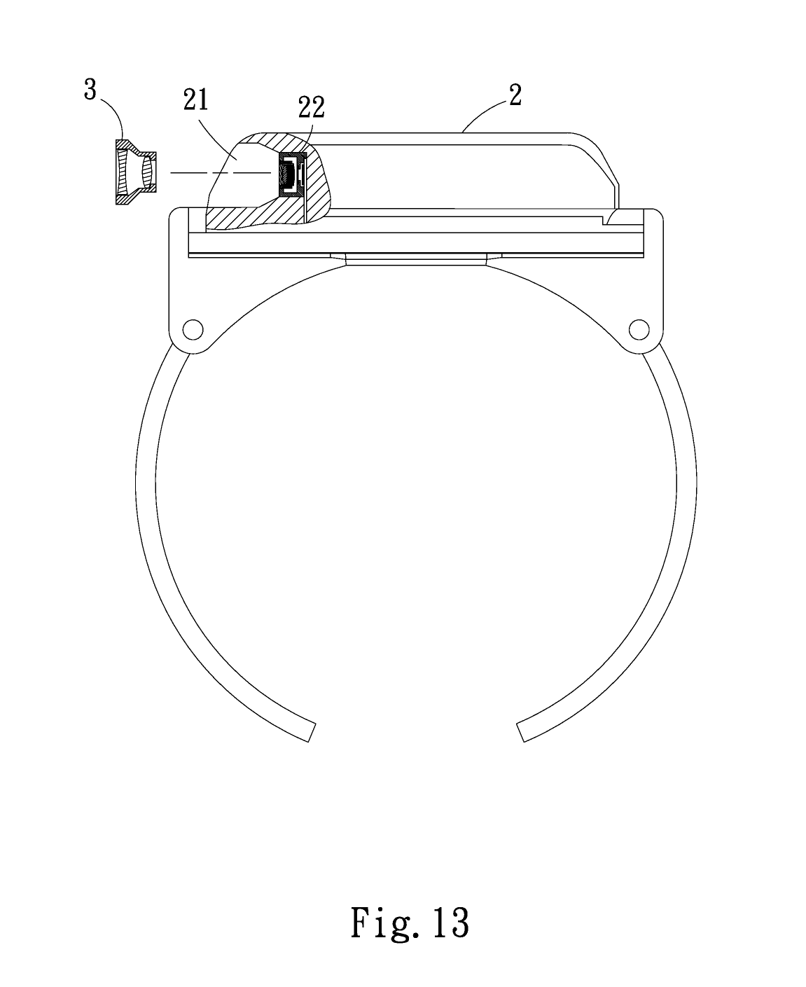

The main housing 2 defines a substantially inverted cone-shaped recess 21 at a lateral side thereof that accommodates therein a CMOS image sensor 22 being electrically connected to a control board (not shown) within the main housing 2. Preferably, the CMOS image sensor 22 is located at an innermost part of the recess 21 (see FIG. 13). The optical assembly 3 is selectively and releasably mounted into the inverted cone-shaped recess 21, corresponding to the CMOS image sensor 22, to allow the optical assembly 3 to be in flush with the side surface of the main housing 2 after mounting the assembly. The optical assembly 3 can be constructed of a wide-angle lens module for providing a wider angle of view, a telephoto lens module for bringing distant objects closer, a close-up lens module for monitoring miniature objects, or a filtering module for reducing undesired light.

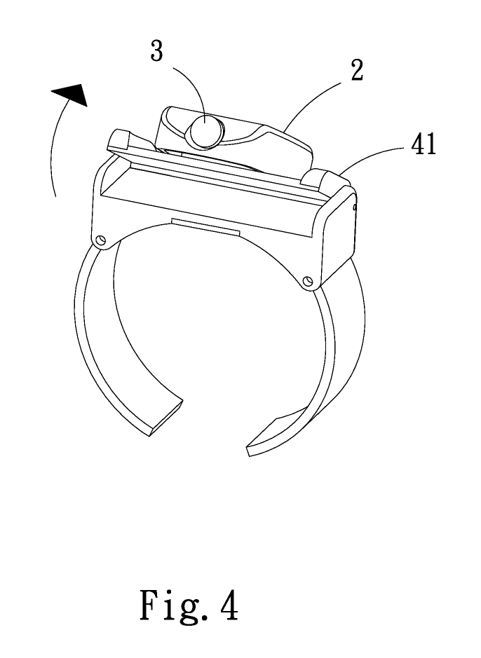

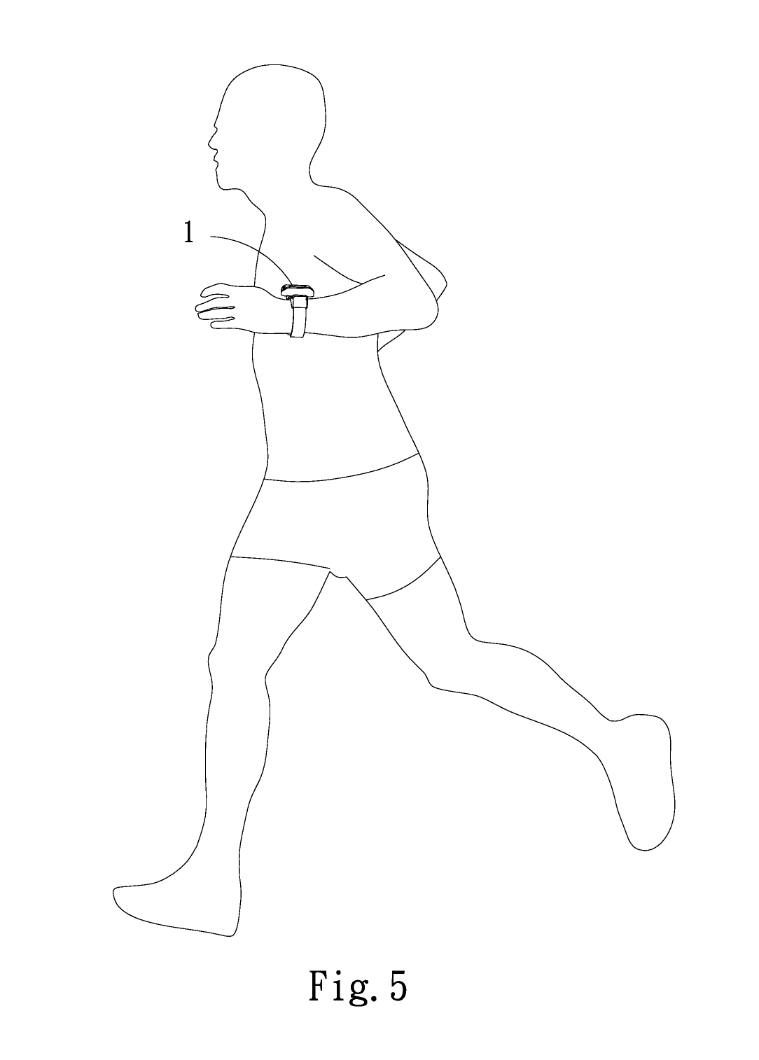

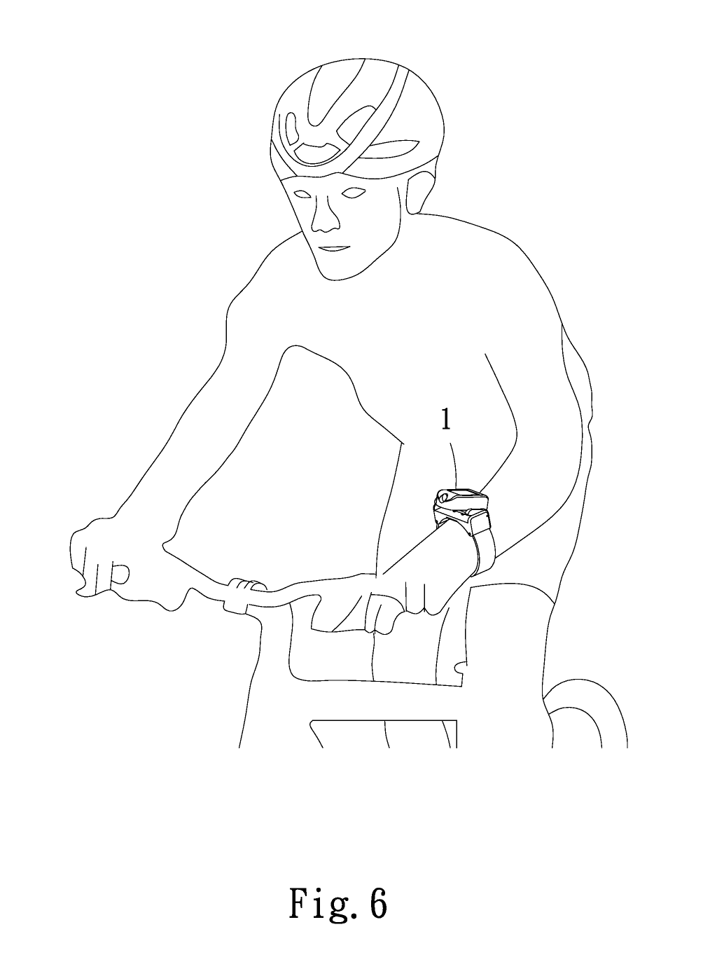

In use, the electronic watch structure 1 of the first embodiment can be fixed to a user's hand by placing the two arched-shaped members 43 around the user's wrist. As such, the user may employ the electronic watch to take photographs or record videos while in jogging, cycling or riding a motorcycle (see FIGS. 5 and 6). Furthermore, the pivotal adjustment plate 41 can be easily and smoothly adjusted at a desired slope (see FIG. 4). The rotatable disk 42 can be rotated at an angle between 0 and 360 degrees (see FIG. 3). These features may further assist a user in taking photographs or recording videos.

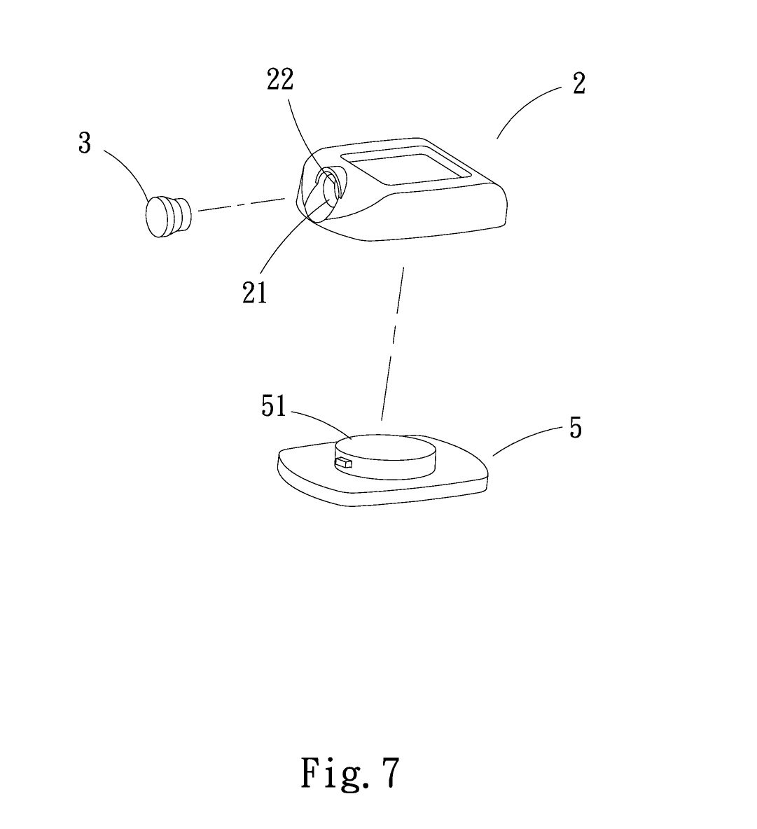

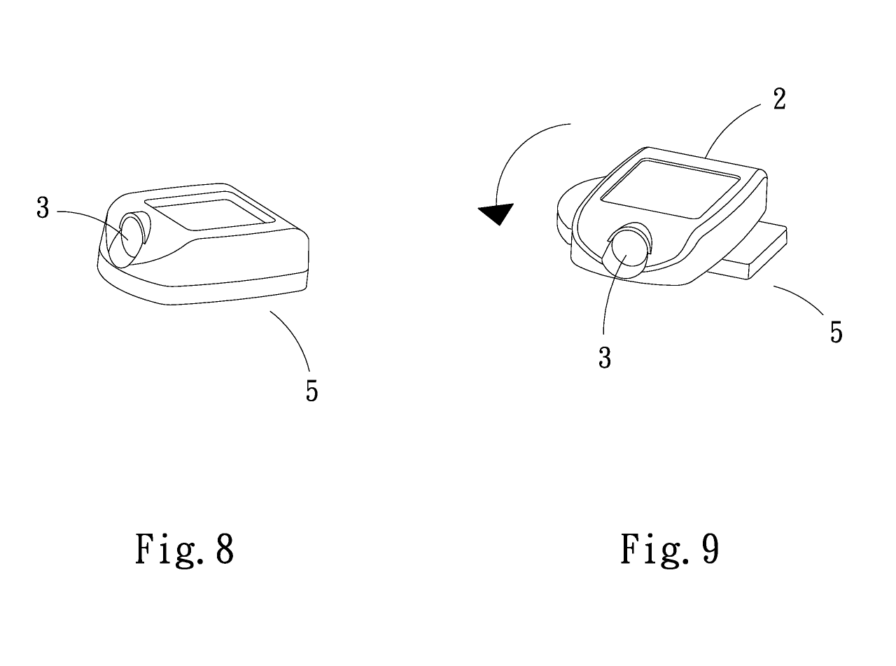

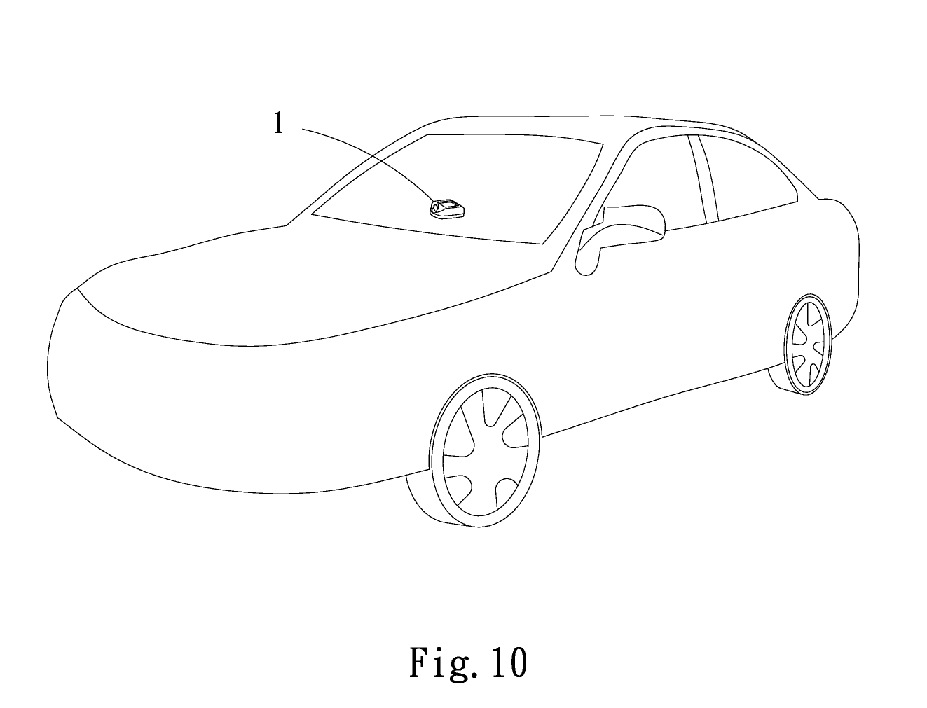

A second embodiment of the invention, concerning an electronic structure, is shown in FIGS. 7 through 12, wherein the electronic watch structure 1 generally comprises a main housing 2, an optical assembly 3, and a base frame 5. The base frame 5 is provided with a rotatable disk 51 on a top surface thereof. The main housing 2 can be mounted onto the rotatable disk 51 of the base frame 5.

The main housing 2 defines a substantially inverted cone-shaped recess 21 at a lateral side thereof that accommodates therein a CMOS image sensor 22 being electrically connected to a control board (not shown) within the main housing 2. Preferably, the CMOS image sensor 22 is located at an innermost part of the recess 21. The optical assembly 3 is selectively and releasably mounted into the inverted cone-shaped recess 21, corresponding to the CMOS image sensor 22, to allow the optical assembly 3 to be in flush with the side surface of the main housing 2 after mounting the assembly. The optical assembly 3 can be constructed of a wide-angle lens module for providing a wider angle of view, a telephoto lens module for bringing distant objects closer, a close-up lens module for monitoring miniature objects, or a filtering module for reducing undesired light.

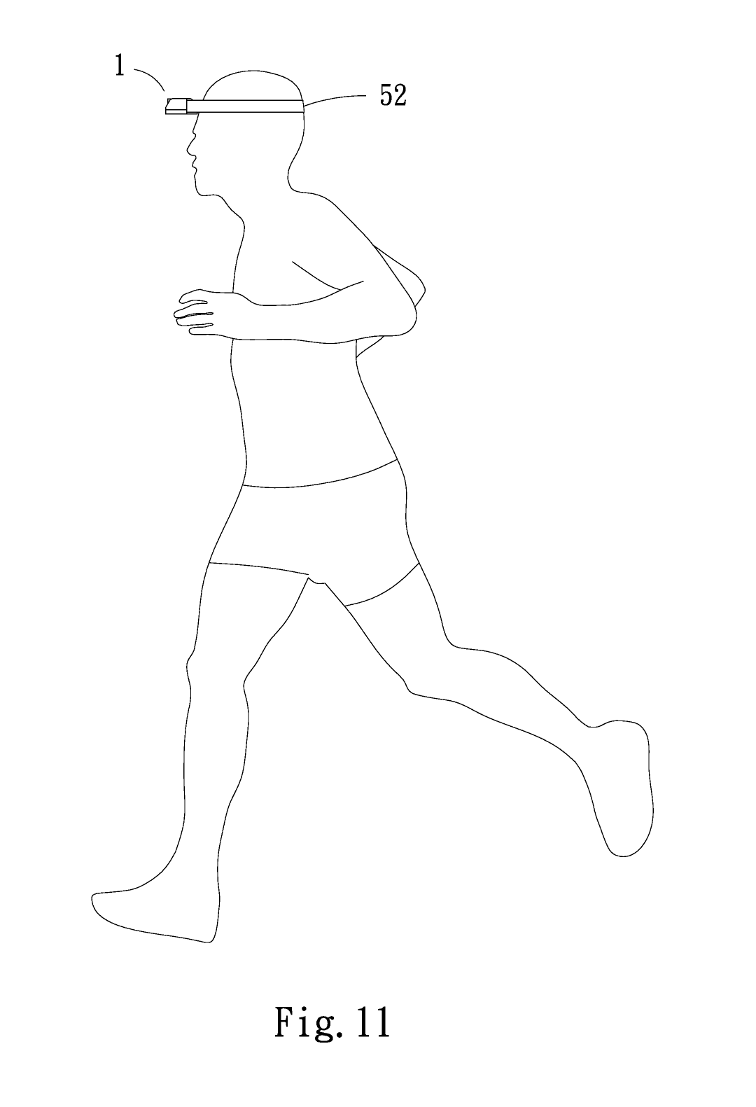

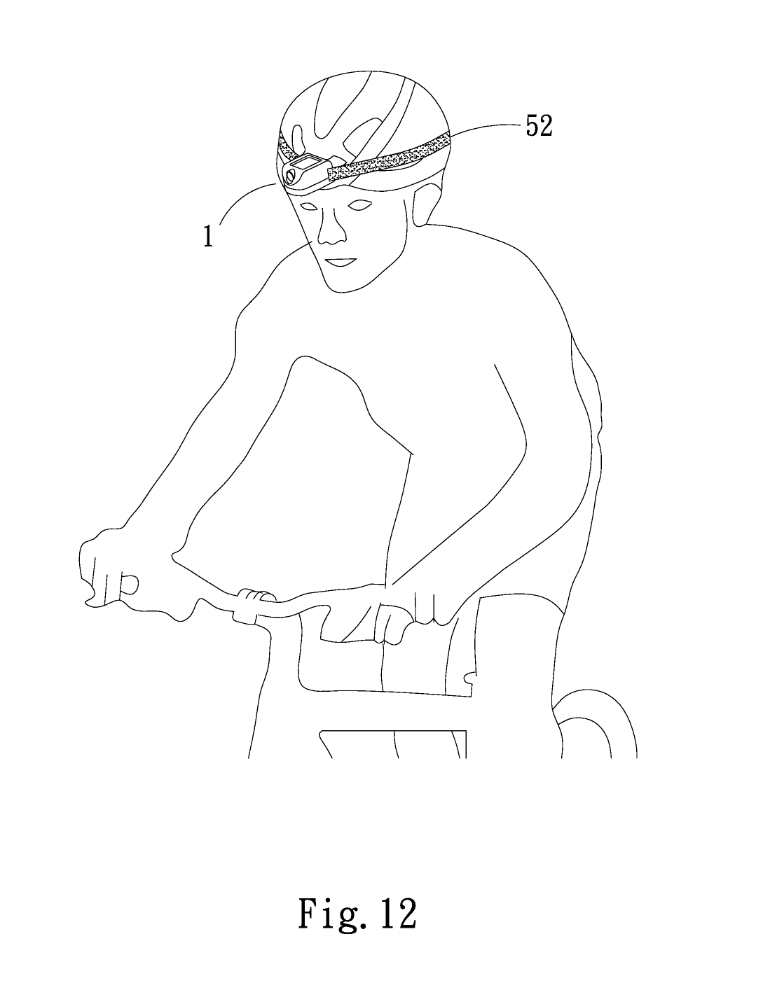

In use, the electronic watch structure 1 of the second embodiment can be fixed to the front or rear side of a vehicle for allowing the electronic watch of the invention to serve as a drive recorder (see FIG. 10). In addition, the electronic watch structure 1 of the second embodiment can be provided with a fastening strap 52 at a side of the base frame 5 opposite to the recess 21. Thus, the electronic watch structure 1 of the second embodiment can be fasten around a user's head or helmet for allowing the user to employ the electronic watch to take photographs or record videos while in jogging, cycling or riding a motorcycle (see FIGS. 11 and 12). Also, the rotatable disk 51 can be rotated at an angle between 0 and 360 degrees, which may further assist the user in taking photographs or recording videos.

The invention makes use of a watch's limited space to allow the CMOS image sensor 22 to be properly located within the main housing 2, and to allow the CMOS image sensor 22 to be cooperated with various types of optical assemblies, each containing a specific high-level optical lens module, for obtaining a desired viewing effect. After mounting the optical assembly 3 into the recess 21, the optical assembly 3 can be located in flush with the side surface of the main housing 2 of the electronic watch. A user can select an optical assembly with a specific optical feature, such as standard viewing, wide-angle viewing, telephoto viewing, close-up viewing, light attenuation or the like, according to a practical requirement, to allow the photographing or videoing function of the electronic watch to be significantly increased.

Furthermore, since the optical assembly 3 is small, light and easy to store, a user can carry several optical assemblies of various functions or factors easily and conveniently. Each optical assembly can be entirely mounted into the inverted cone-shaped recess 21 to allow the top surface thereof to be in flush with the side surface of the main housing 2 of the electronic watch. As such, when a user puts the electronic watch of the invention into the pockets of the user' trousers, since there is no object protruding from the main housing 2 of the electronic watch structure 1, the user will not feel uncomfortable.

Although the invention has been described with a certain degree of particularity, it is understood that the present disclosure is made by way of example only and the combination and arrangement of parts may be resorted to without departing from the spirit and scope of the invention hereinafter claimed.

1-5. (canceled)

6. An electronic watch structure, comprising:
a main housing;
an optical assembly;
a supportive frame including a pivotal adjustment plate that is provided with a rotatable disk on a top surface thereof, wherein the main housing is mounted onto the rotatable disk of the pivotal adjustment plate of the supportive frame, and the supportive frame is provided with two arch-shaped members, a wristband, a bracelet, or a fastening strap at its bottom; and
a base frame including a side fastening strap at a side, and a rotatable disk on a top surface thereof, wherein the main housing is mounted onto the rotatable disk of the base frame;
wherein the main housing defines a substantially inverted cone-shaped recess at a lateral side thereof for disposing a CMOS image sensor therein; and
wherein the optical assembly is selectively and releasably mounted on the CMOS image sensor.
